(19) United States
(12) Patent Application Publication
(10) Pub. No.: US 2011/0213692 A1
(43) Pub. Date: Sep. 1, 2011

(54) Computer-Implemented Systems And Methods For Automatic Triangulation Of Forward Conversion Curves

(76) Inventors: Keith Eugene Crowe, Cary, NC (US); Stacey Michelle Christian, Cary, NC (US); Wei Chen, Apex, NC (US)

(21) Appl. No.: 12/714,984

(22) Filed: Mar. 1, 2010

(51) Int. Cl. G06Q 40/00

(52) U.S. Cl. 705/37; 705/35

(57) ABSTRACT

Systems and methods for determining a future conversion curve between a first metric and a second metric are provided. A system and method can include receiving a first metric and a second metric. A plurality of conversion curves are retrieved, where each conversion curve has a corresponding weight. One or more paths between the first metric and the second metric are calculated using two or more conversion curves, where each path begins with the first metric and ends with the second metric, and where each path is associated with a path weight based upon the sum of the weights used to calculate the path. A shortest path between the first metric and the second metric is determined, where the shortest path is the path having the least weight, and a future conversion curve is generated by collapsing the two or more conversion curves of the shortest path.

### TECHNICAL FIELD

The present disclosure relates generally to computer-implemented systems and methods for converting of future values and more specifically to the determination of future conversion curves.

### BACKGROUND

Conversions between differing metrics are often facilitated through the use of a conversion factor which identifies how many of a second metric is equal to a first metric. An amount measured in the first metric can then be converted so that it can be measured in the second metric by performing a calculation on the amount in the first metric by the conversion factor.

### SUMMARY

In accordance with the teachings provided herein, systems and methods for converting future conversion curves are provided. For example, a system and method can be configured to determine a future conversion curve between a first metric and a second metric. One or more paths between the first metric and the second metric may be calculated using two or more conversion curves. A shortest path between the first metric and the second metric may be determined based on the path having the least weight associated with that path. A future conversion curve may be generated by collapsing the two or more conversion curves of the shortest path.

As another example, a system and method can include receiving a selection of a first metric and a second metric. A plurality of conversion curves may be received, where each conversion curve has a corresponding weight, and where each conversion curve identifies a plurality of future conversions between a source metric and a target metric. One or more paths between the first metric and the second metric may be calculated using two or more conversion curves, where each path begins with the first metric and ends with the second metric, and where each path is associated with a path weight based upon the sum of the weights used to calculate the path. A shortest path between the first metric and the second metric may be determined, where the shortest path is the path having the least weight, and a future conversion curve may be generated by collapsing the two or more conversion curves of the shortest path.

As additional examples, each conversion curve in the plurality of conversion curves may be associated with a plurality of future times, where the two or more conversion curves of the shortest path are normalized with respect to one another. The normalizing may include linear interpolation. One of the one or more paths between the first metric and the second metric may include a backward link from a target metric to a source metric, and the backward link may have the same weight as a corresponding forward link. Each conversion curve in the plurality of conversion curves may be associated with a plurality of future times. Collapsing two or more conversion curves may include calculating a product for each conversion curve at a predetermined future time and generating a future conversion curve based upon the calculated product.

As further examples, each conversion curve in the plurality of conversion curves may be associated with a plurality of future times, where an inverse future conversion is used when a backward link is present in the shortest path. Collapsing two or more conversion curves may include calculating a product for each inverse future conversion curve at a predetermined time and generating an inverse future conversion curve based upon the calculated product. Each weight may be equal, where the shortest path between the first metric and the second metric includes the fewest number of conversion curves. One or more paths between the first metric and the second metric may be calculated using a Dijkstra's algorithm or a Bellman-Ford algorithm. The path having the least weight may be chosen from a path having the highest sum of weights or a path having the lowest sum of weights. Calculating one or more paths may include not calculating all possible paths between the first metric and the second metric.

Particular embodiments of the subject matter described in this specification can be implemented to realize one or more of the following advantages including determining a forward conversion curve between a first metric and a second metric where no direct conversion between the first metric and the second metric is known, a high computational efficiency through leveraging shortest path algorithms, the ability to affect a choice of paths away from undesirable conversions through assignments of weights, generating additional known conversion curves for future use, as well as others.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 shows a block diagram of an example system for determining a future conversion curve between a first metric and a second metric.

FIG. 2 is a graph depicting an example conversion curve.

FIG. 3 is a block diagram depicting an example future conversion curve calculator for determining a first conversion curve between a first metric and a second metric.

FIG. 4 is a depiction of an example directed graph representing a plurality of conversion curves between source metrics and target metrics.

FIG. 5 depicts the generation of an example future conversion curve based upon a plurality of conversion curves.

FIG. 6 depicts an example collection of known relationships.

FIG. 7 depicts an example collection of known relationships expressed as a directed graph.

FIG. 8 is a flow diagram depicting example preprocessing that can be performed by a future conversion curve generator.

FIG. 9 is a flow diagram depicting an example process for determining a forward exchange rate curve.

FIG. 10 is a directed graph depicting known conversion curves from Japanese Yen to Euros and Euros to U.S. Dollars.

FIG. 11 is a directed graph depicting example known conversion curves.

FIG. 12 is a flow diagram depicting an example computer-implemented method for determining a future conversion curve between a first metric and a second metric.

### DETAILED DESCRIPTION

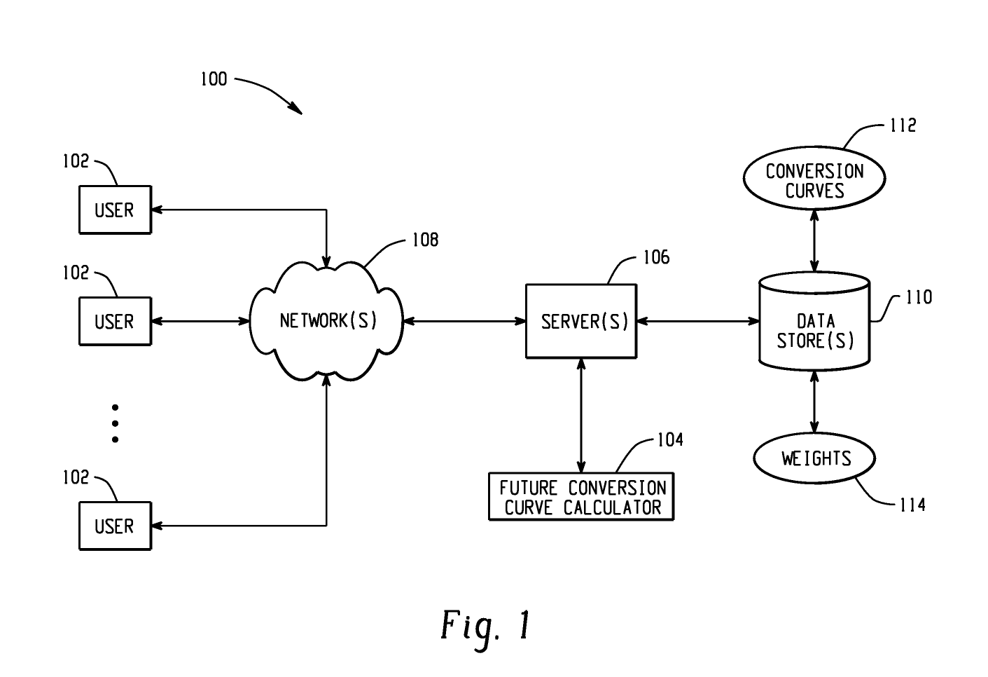

FIG. 1 shows a block diagram of an example system for determining a future conversion curve between a first metric and a second metric. The system 100 can be a computer-implemented environment wherein one or more users 102 can interact with a future (forward) conversion curve calculator 104 hosted on one or more servers 106 through a network 108. The future conversion curve calculator 104 contains software operations or routines for determining a future conversion curve between a first metric and a second metric based upon a plurality of known conversion curves. The users 102 can interact with the future conversion curve calculator 104 through a number of ways, such as over one or more networks 108. It should be understood that the future conversion curve calculator 104 could also be provided on a stand-alone computer for access by a user.

The future conversion curve calculator 104 can be an integrated web-based analysis tool that provides users 102 flexibility and functionality for performing a determination of a future conversion curve between a first metric and a second metric. The future conversion calculator 104 can also be a wholly automated system. The future conversion calculator 104 can interact with a human user or with one or more computer programs. One or more data stores 110 can store the data to be analyzed by the future conversion curve calculator 104 as well as any intermediate or final data generated by the future conversion curve calculator 104. For example, the data store(s) 110 can store known conversion curves 112 for use in determining the future conversion curve as well as weights 114 for use in selecting conversion curves utilized in the determination. Examples of data store(s) 110 can include relational database management systems (RDBMS), a memory, a flat-file, or a multi-dimensional database (MDDB), such as an Online Analytical Processing (OLAP) database, etc.

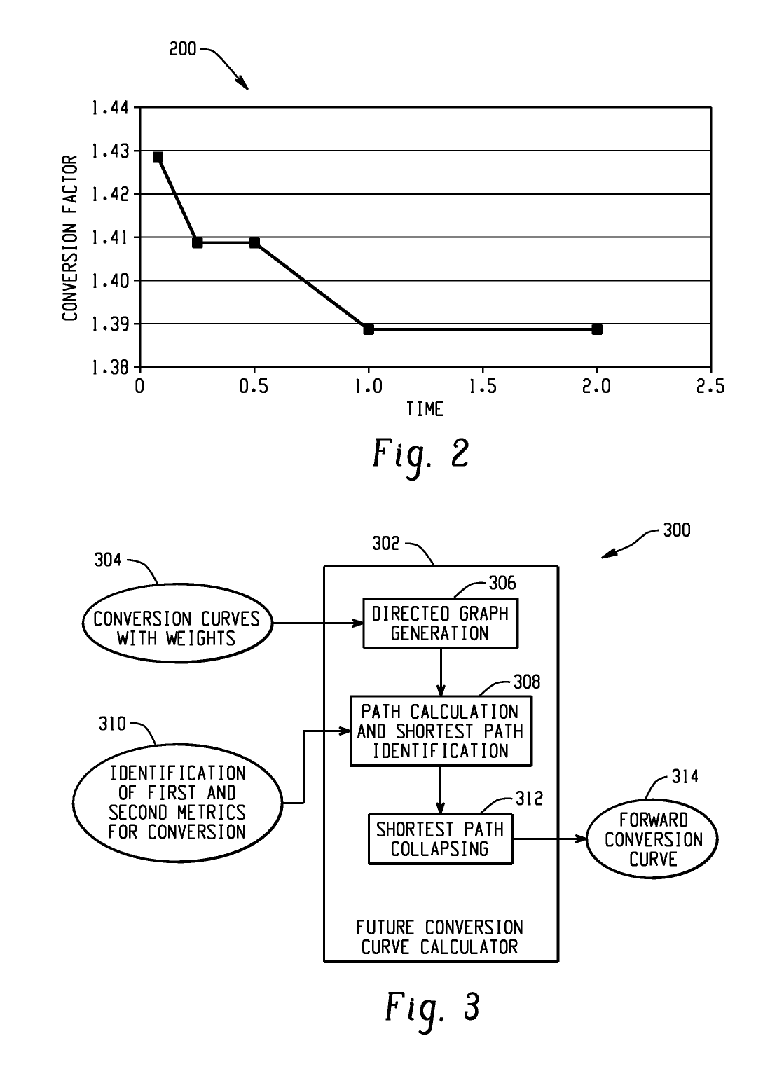

FIG. 2 is a graph depicting an example conversion curve. A conversion curve 200 identifies conversion factors (e.g., depicted on the Y-axis), at a plurality of future times (e.g., depicted on the X-axis). Performing conversions from a first metric to a second metric can include multiplying a total of the first metric by a conversion factor or the inverse of a conversion factor to convert the total in the first metric into the second metric. For example, at time 0.5, the conversion factor between a source metric and a target metric is 1.408. At time 2.0, the conversion factor between a source metric and a target metric is 1.388. Thus, in this example, to convert a total in the source metric to the target metric at time 0.5, the total in the source metric can to be multiplied by a conversion factor of 1.408. Similarly, to convert a total in the source metric to the target metric at time 2.0, the total in the source metric can be multiplied by a conversion factor of 1.388. In some implementations, a conversion curve can also be used in reverse by multiplying a total in the target metric by the inverse of the conversion factor to convert the total to the target metric to the source metric. For example, to convert a total in the target metric to the source metric at time 0.5, the total in the target metric can be multiplied by 1/1.408.

A conversion from a first metric to a second metric becomes more complicated when a direct conversion curve from the first metric to the second metric is unknown (e.g., if a user wishes to make a conversion from a first metric to a second metric, and the only known conversion curves are from the first metric to a third metric; from the third metric to a fourth metric; or from the fourth metric to the second metric), then a series of conversions (e.g., using multiple conversion curves), can be executed to perform the conversion from the first metric to the second metric.

FIG. 3 is a block diagram depicting an example future conversion curve calculator for determining a first conversion curve between a first metric and a second metric. In some implementations, a direct conversion curve between a first metric and a second metric may not be known. In these implementations, the future conversion curve calculator 302 can receive a plurality of conversion curves 304. Each conversion curve can identify a plurality of future conversions between a source metric and a target metric. The future conversions can be stored in a variety of formats, such as an array data structure, one or more records in a relational database, records in a spreadsheet, as well as other formats. The future conversions and their associated times can be plotted on a graph (e.g., as shown in FIG. 2).

Each conversion curve can also be associated with a weight. A weight can correspond to the desirability of using the associated conversion curve to perform a conversion. In some implementations, a small value may be associated with particular conversion curves (e.g., to connote a low cost of using that conversion curve). Alternatively, a high value may be associated with particular conversion curves (e.g., to connote the higher desirability of using that conversion curve). Thus, depending on the weighting protocol, a most desirable path of conversion curves can have a highest sum of weights of all calculated paths or a lowest sum of weights of all calculated paths.

The same or different weights can be associated with a conversion curve for forward or backward traversals of that conversion curve. For example, a weight of 2 may be associated with the forward traversal of a conversion curve from metric A to metric B, while a weight of 4 may be associated with the backward traversal of that conversion curve from metric B to metric A. Each conversion curve can have a differing weight with respect to other conversion curves, or each conversion curve can be associated with a common weight, thereby yielding a “shortest-path” in the literal sense of the phrase.

The future conversion curve calculator 302 can receive a plurality of conversion curves between a source metric and a target metric and can generate a directed graph at 306. A directed graph can identify a network of possible conversions enabled by the received plurality of conversion curves 304. At 308, the future conversion curve calculator 302 can receive an identification of a first metric and a second metric 310. The future conversion curve calculator 302 can perform a conversion between the received first metric and the received second metric. The future conversion curve calculator can calculate one or more paths between the received first metric and the received second metric using the directed graph generated at 306. A path can begin with a conversion curve that includes the received first metric and ends with a conversion curve that includes the received second metric. A path can further include one or more intermediate conversion curves between the received first metric and the received second metric.

The path calculation at 308 can perform an exhaustive search for all possible paths through the directed graph, or the path calculation at 308 may identify a subset of all possible paths. For example, the path calculation 308 can avoid identifying paths that form cycles (e.g., by traversing nodes multiple times). The calculated paths can be analyzed (e.g., to calculate a path weight). In some implementations, a path weight can be determined by calculating a sum of the weights of all conversion curves used in that path. A path having the least weight (e.g., the shortest path that can be used to generate a future conversion curve) can be determined to be the most desirable path. Example algorithms for computing a shortest path include a Dijkstra's algorithm, which can be used for example, if all weights are non-negative, and the Bellman-Ford algorithm, which can be used for example, when negative weights are expected.

At 312, the determined shortest path can be collapsed to generate a single future conversion curve 314 between the received first metric and the received second metric. Collapsing the plurality of conversion curves on a determined shortest path can be performed by calculating a product for all of the conversion factors associated with the conversion curves at a particular time. For example, if the shortest path includes Conversion Curve A, Conversion Curve B, and Conversion Curve C, with conversion factors at 0.5 years, 1.0 years, and 2.0 years, then future conversion curves can be generated according to:

FutureConversionCurve(0.5)=Conversion Curve A(0.5)*Conversion Curve B(0.5)*Conversion Curve C(0.5);

FutureConversionCurve(1.0)=Conversion Curve A(1.0)*Conversion Curve B(1.0)*Conversion Curve C(1.0); and

FutureConversionCurve(2.0)=Conversion Curve A(2.0)*Conversion Curve B(2.0)*Conversion Curve C(2.0).

The future conversion curve calculator 302 can output a future conversion curve 314. Additionally, the future conversion curve calculator 302 can retain future conversion curve 314 (e.g., for use as an additional curve in the plurality of conversion curves 304 used in conversion calculations).

In some implementations, the plurality of conversion curves 304 can be normalized with one another prior to collapsing the shortest path at 312. For example, if the desired output future conversion curve includes conversion factors at times: 0.5 years, 1.0 years, and 2.0 years, and Conversion Curve B on a shortest path does not include a conversion factor at 1.0 years, then Conversion Curve B can be normalized. In this example, Conversion Curve B can be normalized (e.g., to the other conversion curves on the shortest path and the future conversion curve to be output), by using linear interpolation to estimate the conversion factor for Conversion Curve B at 1.0 years. The linear interpolation can be based upon conversion factors for times in close proximity to Conversion Curve B (e.g., conversion factors for times 0.8 years and 1.3 years included in the known Conversion Curve B). Other methods of normalization may also be used including spline interpolation.

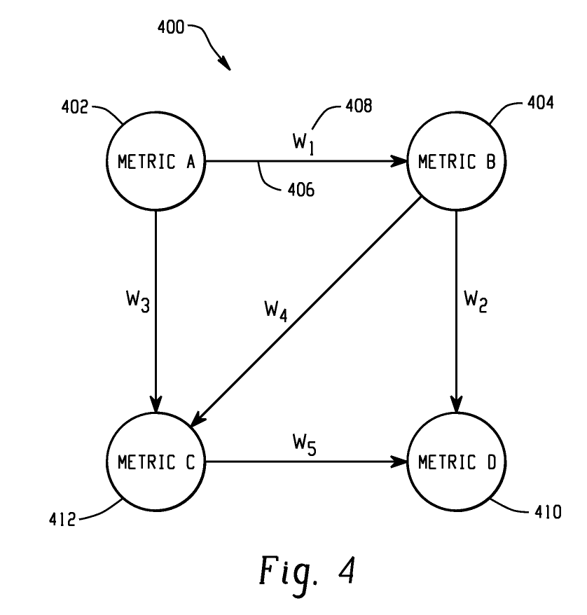

FIG. 4 is a depiction of an example directed graph representing a plurality of conversion curves between source metrics and target metrics. Each of the plurality of known conversion curves can identify a source metric and a target metric. This can be represented in a directed graph (e.g., directed graph 400), using the direction of the arrows. For example, a first conversion curve between Source Metric A 402 and Target Metric B 404 can be represented by an arrow 406 from Metric A 402 to Metric B 404. The depiction of the directed graph 400 can also identify weights associated with the conversion curves, such as weight W₁ 408 associated with the conversion curve from Metric A 402 to Metric B 404.

The directed graph 400 representing the plurality of conversion curves shows multiple possible paths for converting from a first metric to a second metric. For example, to convert from Metric A 402 to Metric D 410, a path can run from Metric A 402 to Metric B 404 to Metric D 410, from Metric A 402 to Metric C 412 to metric D 410, or from Metric A 402 to Metric B 404 to Metric C 412 to Metric D 410. The weights for each of these paths can be calculated as follows:

Metric A->Metric B->Metric D=W₁+W₂;

Metric A->Metric C->Metric D=W₃+W₅; and

Metric A->Metric B->Metric C->Metric D=W₁+W₄₊W₅.

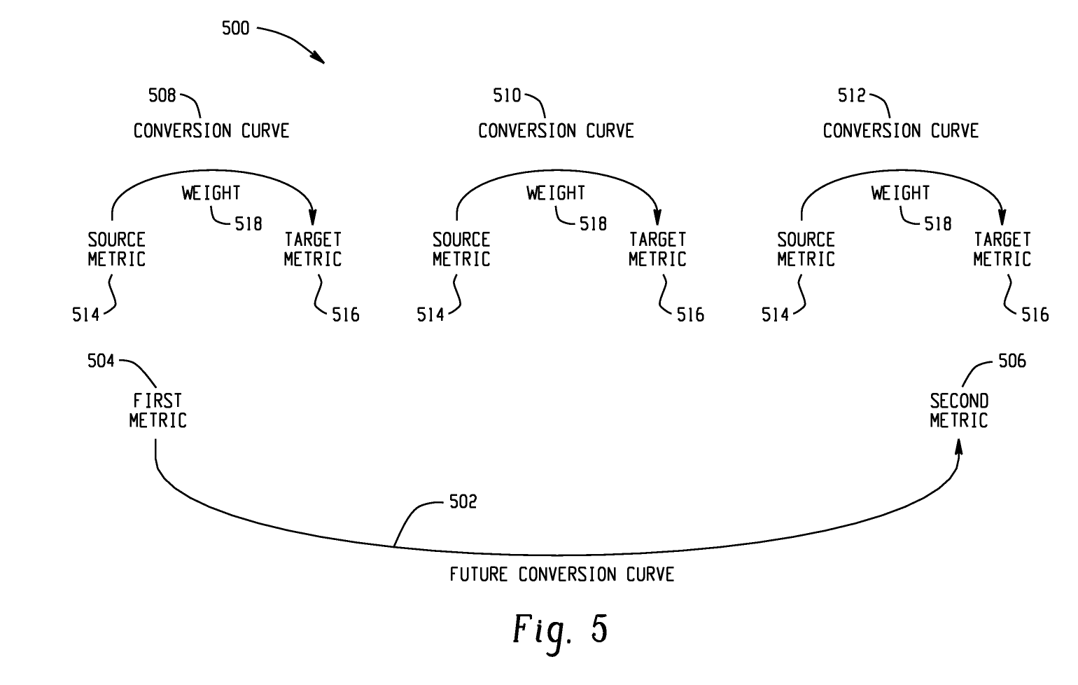

FIG. 5 depicts the generation of an example future conversion curve based upon a plurality of conversion curves. The future conversion curve 502 can provide conversion factors for converting totals from a first metric 504 to a second metric 506 at multiple times in the future. The future conversion curve 502 can be generated based upon a plurality of intermediate conversion curves 508, 510, 512. Each conversion curve can identify a source metric 514 and a target metric 516, a weight 518 associated with the conversion curve, as well as a plurality of conversion factors. The path of conversion curves 508, 510, 512 that can be used to generate the future conversion curve 502 begins with a first conversion curve 508 that includes the first metric 504 and ends with a second conversion curve 512 that includes the second metric 506. In the example of FIG. 5, the path further includes an intermediate conversion curve 510.

A future conversion curve calculator can be useful in a variety of applications. For example, a future conversion curve calculator can be used for calculating forward currency exchange curves. An organization oftentimes deals with more than one currency. A financial system for the organization should be able to handle multiple currency conversions quickly and efficiently. Currency risk management can be an important element of a financial risk management system (e.g., doing business in a fluctuating foreign currency exchange market).

A forward currency exchange curve includes a sequence of forward currency exchange rates and an associated delivery time for each rate. The forward currency exchange curve can be created by joining each delivery date and rate as an ordered pair and placing the pairs on a grid, such as the grid shown in FIG. 2. The forward currency exchange rates can be generated in a variety of manners. The forward currency exchange rates can be a negotiated relation between two currencies at a future date that can be extracted, for example, from a futures market. The forward currency exchange rates could also be predicted based on various economic factors correlated with the forward rates.

As an example, a future conversion curve calculator can be provided with a first forward currency exchange curve from currency U.S. Dollar (USD) to currency Euro (EUR), and a second forward exchange curve from currency British Pound (GBP) to currency Euro (EUR). Using these two rate curves, it is possible to construct a new rate curve from currency GBP to currency USD. As noted above, the future conversion curve calculator can configure triangulation of rate curves between currencies using any number of currency curves (e.g., “n” currency curves). Thus, the future conversion curve calculator can include a minimal set of curves with available data, because the future currency curve calculator can deduce other curves as needed (e.g., other curves that don't have available data). The future conversion curve calculator can determine whether defined intermediate curves can be used to construct a new curve between two particular currencies. Additionally, the future conversion curve calculator can choose a desirable set of intermediate curves (e.g., when more than one set of intermediate curves exist).

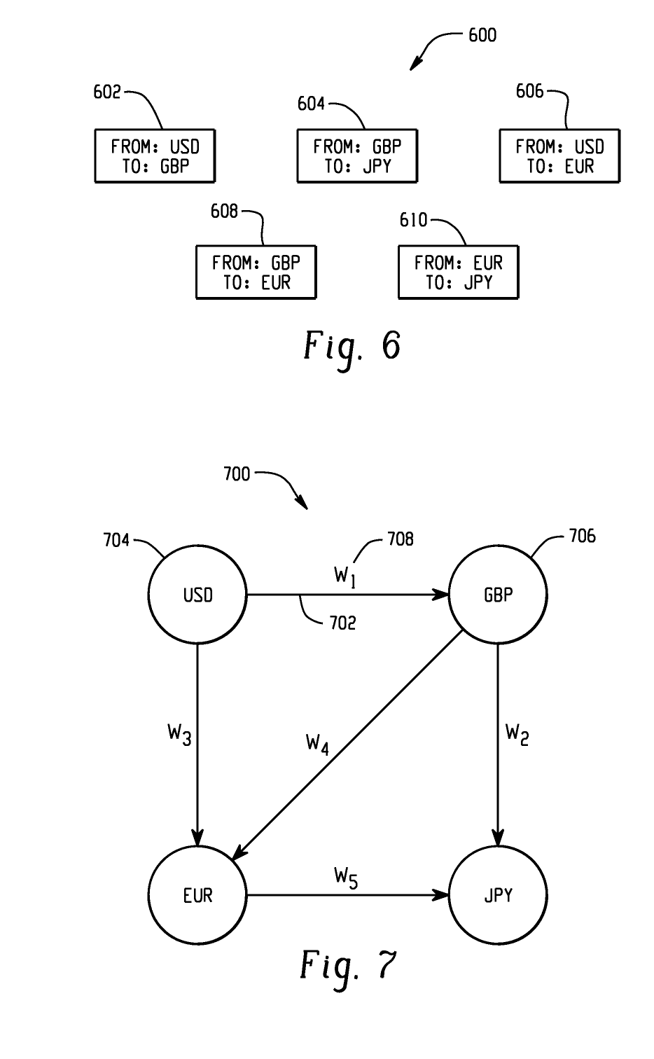

In some implementations, to determine a set of intermediate curves for triangulation, the future conversion curve calculator can treat available conversion curves as a single, weighted, directed, disconnected graph. Each currency can be mapped to a vertex in the graph. An edge can connect any two vertices that define a rate curve corresponding to two currencies. FIG. 6 depicts an example collection of known relationships. The known currency relationships include USD to GBP 602, GBP to Japanese Yen (JPY) 604, USD to Euro 606, GBP to JPY 608, and Euro to JPY 610. FIG. 7 depicts an example collection of known relationships expressed as a directed graph. In this example collection, conversions between pairs of the five currencies are identified by an arrow between two nodes (e.g. the arrow 702 between USD 704 and GBP 706 represents the known currency relationship 602 between USD and GBP shown in FIG. 6). Additionally, in this example, conversions are given a weight, wᵢ (e.g., weight w₁ 708 associated with the known conversion curve between USD and GBP).

Weights can be assigned to the edges of a directed graph such that the weights can encourage or discourage the choice of a particular path (e.g., through certain vertices). For example, strong inflationary pressures in a national economy can create a desire to avoid using the currency association with that national economy in a triangulation. This can be accomplished by assigning large weights to the edges of the directed graph. Impinging on the vertex corresponding to the unstable currency can represent a high cost of using that conversion. Other factors in assigning a weight to a conversion curve can include unfavorable contract terms for performing the conversions, or lack of liquidity of a currency.

In some implementations, a weighting scheme can assign equal weights to each edge. Because the cost of a path is the sum of the weights of all edges along the path, if all edges are of equal weight, then a shortest path algorithm would find a shortest path through the graph that utilizes the fewest number of intermediate vertices.

Following the determination of the shortest path of curves, numerical calculations for the rates of a new forward curve can be generated. The results of the shortest path determination can identify which known curves to use, and in which order the known curves should be used. Additionally, conversion curve inversions, as described herein above, can be necessitated by reverse conversion directions specified in the shortest path.

In some implementations, when the delivery dates and the number of deliveries within each intermediate curve are identical, then the conversion rates for the future conversion curve can be calculated for each corresponding delivery date. However, if the number of delivery dates or a specific delivery dates differs from one curve to another, then the curves can be normalized (e.g., using linear interpolation), to create a set of common delivery dates.

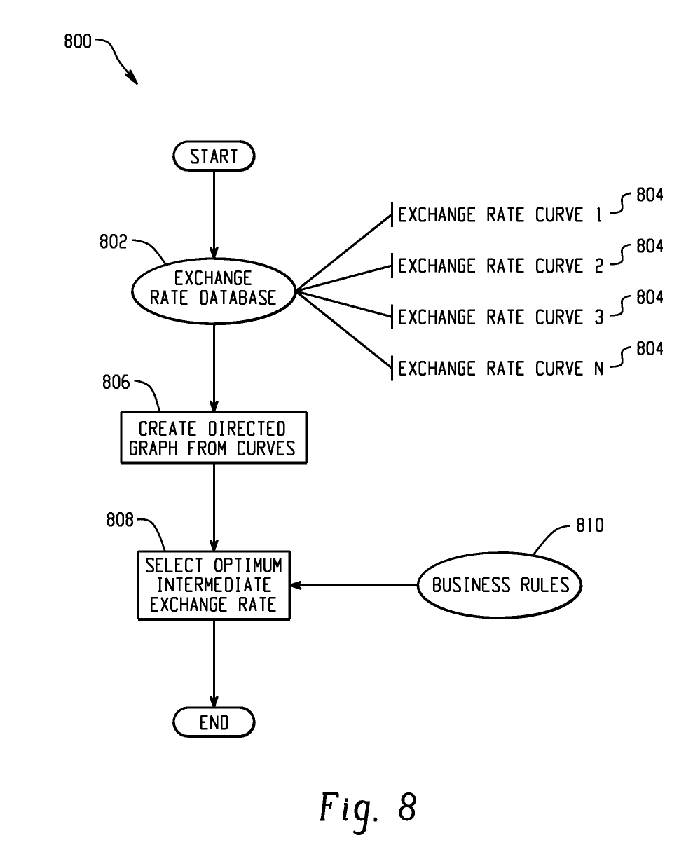

FIG. 8 is a flow diagram depicting example preprocessing that can be performed by a future conversion curve generator. At 802, an exchange rate database is populated with a number of known exchange rate curves (1 . . . N) 804. For example, the known exchange rate curves can be similar to those recited in FIG. 6. At 806, a directed graph is created from the known exchange rate curves 804 in the exchange rate database 802. The runtime process of selecting the optimum intermediate exchange rates at 808 can receive the directed graph generated at 806 along with one or more business rules 810. The one or more business rules 810 can be in the form of weights that are associated with the known exchange rate curves 804.

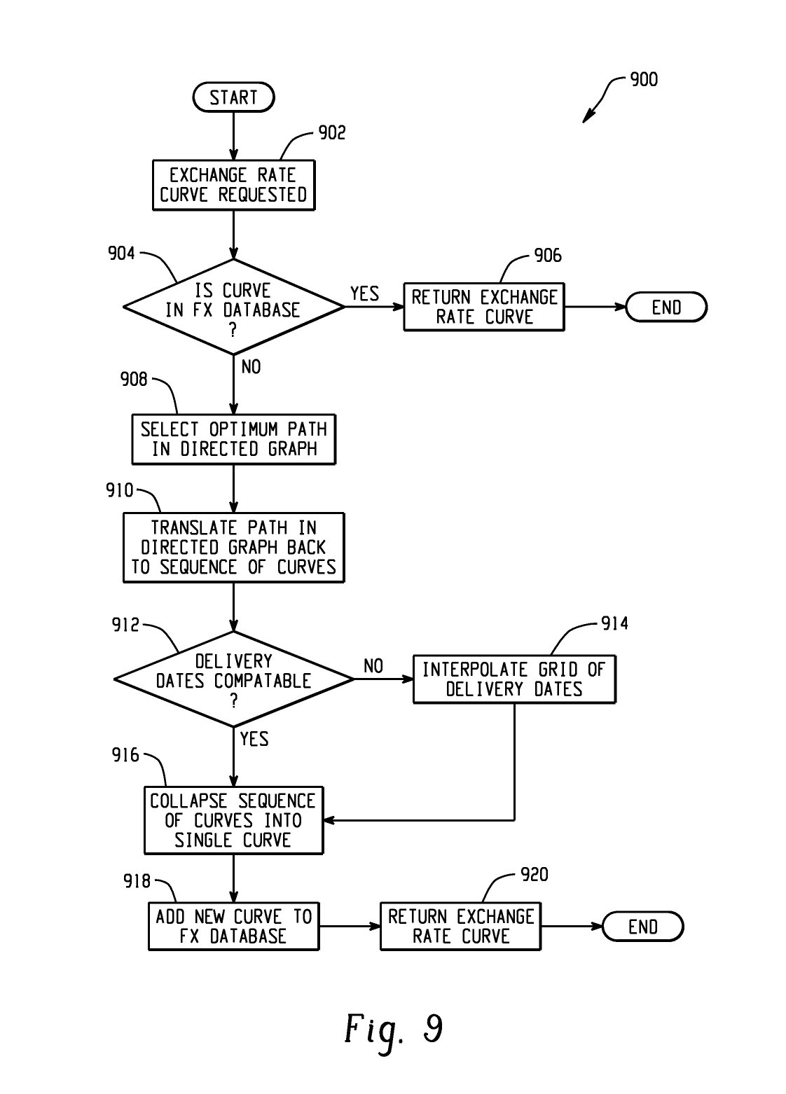

FIG. 9 is a flow diagram depicting an example process for determining a forward exchange rate curve. The system receives a request for an exchange rate curve between a first currency and a second currency at 902. At 904, the system makes a determination as to whether the requested exchange rate curve is a known exchange rate curve contained in a database of the future conversion curve calculator. If the requested exchange rate curve is known, then the system returns the requested curve at 906. At 908, an optimum path from the first currency to the second currency in the directed graph of known exchange rate curves can be identified by the system (e.g., using a shortest path algorithm). In step 908, the system can return the path or an identification that no path can be calculated based upon the known exchange rate curves. At 910, the system can translate the identified optimum path back into a sequence of known curves.

At 912, the system can make a determination as to whether the delivery dates of the known exchange curves on the determined optimum path are compatible. If the delivery dates are not compatible, then the system can estimate rates at common times throughout the curves along the determined optimum path (e.g., using linear interpolation), at 914. When the exchange rate curves along the determined optimum path have a plurality of compatible delivery dates, the system can collapse the exchange rate curves along the optimum path (e.g., by multiplying the exchange rates of all of the known exchange rate curves on the optimum path at each compatible date), at 916. The system can add the newly generated exchange rate curve to the database of known exchange rate curves at 918, and the system can return the exchange rate curve from the first currency to the second currency at 920.

Example scenarios, algorithms, and code segments are provided herein to further illustrate a future conversion curve calculator determining a future conversion curve between a first currency and a second currency where a direct conversion between the first currency and the second currency is unknown.

The following code may be utilized to define 15 risk factor variables representing exchange rates between three pairs of currencies at different future times:

```
declare riskfactors = (
    usdeur1m num fx tocur = USD fromcur = EUR maturity=1 month,
    usdeur3m num fx tocur = USD fromcur = EUR maturity=3 month,
    usdeur6m num fx tocur = USD fromcur = EUR maturity=6 month,
    usdeur1y num fx tocur = USD fromcur = EUR maturity=1 year,
    usdeur2y num fx tocur = USD fromcur = EUR maturity=2 year,
    eurjpy1m num fx tocur = EUR fromcur = JPY maturity=1 month,
    eurjpy3m num fx tocur = EUR fromcur = JPY maturity=3 month,
    eurjpy6m num fx tocur = EUR fromcur = JPY maturity=6 month,
    eurjpy1y num fx tocur = EUR fromcur = JPY maturity=1 year,
    eurjpy2y num fx tocur = EUR fromcur = JPY maturity=2 year,
    usdjpy1m num fx tocur = USD fromcur = JPY maturity=1 month,
    usdjpy3m num fx tocur = USD fromcur = JPY maturity=3 month,
    usdjpy6m num fx tocur = USD fromcur = JPY maturity=6 month,
    usdjpy1y num fx tocur = USD fromcur = JPY maturity=1 year,
    usdjpy2y num fx tocur = USD fromcur = JPY maturity=2 year).
```

For example:
usdeur6m num fx tocur=USD fromcur=EUR maturity=6 month,
   defines a numeric variable named usdeur6m containing a value used to convert from EUR to USD in 6 months. Likewise,
usdjpy1m num fx tocur=USD fromcur=JPY maturity=1 month,
   defines a numeric variable named usdjpy1m containing a value used to convert JPY to USD in 1 month.

The variables which convert between the same currencies can be sequenced into arrays as follows:

array usdeurc fx tocur=USD fromcur=EUR
elements=(usdeur1m usdeur3m usdeur6m usdeur1y usdeur2y)
refmap=(fx_curve=“EUR:USD”);

array eurjpyc fx tocur=EUR fromcur=JPY
elements=(eurjpy1m eur)py3m eurjpy6m eurjpy1y eurjpy2y)
refmap=(fx_curve=“JPY:EUR”);

array usdjpyc fx tocur=USD fromcur=JPY
elements=(usdjpy1m usdjpy3m usdjpy6m usdjpy1y usdjpy2y)
refmap=(fx_curve=“JPY:USD”).
   The first array definition creates an array named usdeurc used to convert from EUR to USD. The first array contains five variables usdeur1m, usdeur3m, usdeur6m, usdeur1y, usdeur2y. Likewise, the arrays eurjpyc and usdjpyc group exchange variables between respective currencies.

An example set of values for the first array, usdeurc, could define:

usdeur1m=1.43; usdeur3m=1.41; usdeur6m=1.41; usdeur1y=1.39; usdeur2y=1.39.

A typical application of these rates can include a cash flow analysis with desired reporting currency in U.S. Dollars where, during analysis, a bond position denominated in Euros is encountered. Using the relationships in the usdeurc array, the date of the coupon can be matched against an appropriate maturity on the forward exchange curve stored in the usdeurc array to determine the conversion rate. For example, when evaluating a Euro-valued coupon one year later, the value in euros can be multiplied by 1.39 to give equivalent U.S. Dollars. Similarly, a Euro-valued coupon redeemed in three months can be multiplied by 1.41 to obtain that amount in U.S. Dollars. If a maturity is required that is not explicitly given in the curve, linear interpolation can be used to find an exchange rate.

In a further cash flow analysis, a bond denominated in Japanese Yen can be processed. A curve defining conversions from JPY to USD is therefore needed. In this example, an array for containing such a curve can be named usdjpyc. If usdjpyc is not defined in the system, conversion from JPY to USD cannot be completed.

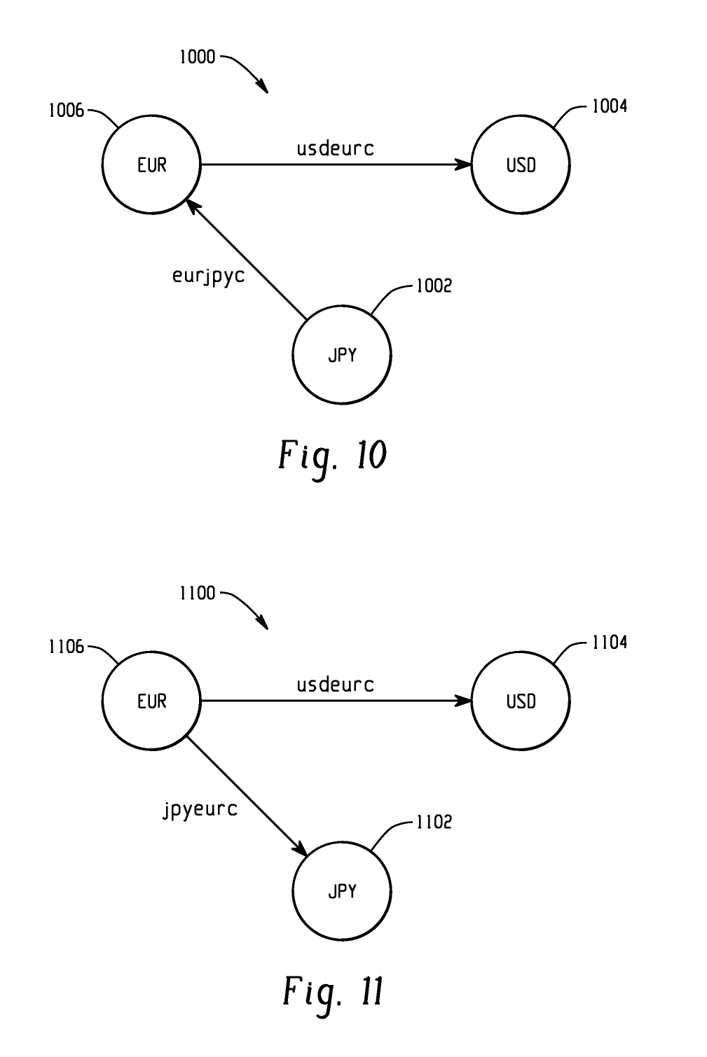

FIG. 10 is a directed graph depicting known conversion curves from Japanese Yen to Euros and Euros to U.S. Dollars. These known conversions may be stored in the following array definitions:

array usdeurc fx tocur=USD fromcur=EUR
elements=(usdeur1m usdeur3m usdeur6m usdeur1y usdeur2y)
refmap=(fx_curve=“EUR:USD”);

array eurjpyc fx tocur=EUR fromcur=JPY
elements=(eurjpy1m eurjpy3m eurjpy6m eurjpy1y eurjpy2y)
refmap=(fx_curve=“JPY:EUR”);
   In some implementations, having a position denominated in JPY with a reporting currency of USD can trigger an exchange rate curve request, querying the known conversion curves database. However, as shown in FIG. 10, there is no edge connecting the USD 1004 and JPY 1002 nodes. Thus, the database does not contain the required curve. Therefore, a shortest path algorithm can be applied to the directed graph of FIG. 10 starting with the JPY node 1002 ending with the USD node 1004. The algorithm returns the only possible path, namely JPY->EUR->USD. This path yields the curve sequence {eurjpyc(F), usdeurc(F)}. In this example, because only forward traversals of the known conversions JPY->EUR and EUR->USD are utilized, (as denoted by the (F) identifiers), the conversion factors contained in the arrays can be used to generate the desired forward conversion curve. However, if a backwards traversal were utilized, inverses of the conversion rates contained in the arrays could be utilized to collapse the known conversion curves (e.g., along the shortest path).

Once the components for generating a forward conversion curve from JPY to USD have been identified, the corresponding curve delivery dates can to be considered. For example, when each of the curves in the shortest path contains maturities of 1 month, 3 month, 6 month, 1 year and 2 years, no interpolation is necessary.

The known conversion curves along the identified shortest path can be collapsed to generate a future conversion curve between JPY and USD. Variables for holding the component rates and an array for holding those variables can be defined as:

usdjpy1m num fx tocur=USD fromcur=JPY maturity=1 month,

usdjpy3m num fx tocur=USD fromcur=JPY maturity=3 month,

usdjpy6m num fx tocur=USD fromcur=JPY maturity=6 month,

usdjpy1y num fx tocur=USD fromcur=JPY maturity=1 year,

usdjpy2y num fx tocur=USD fromcur=JPY maturity=2 year.

and

array usdjpyc fx tocur=USD fromcur=JPY
elements=(usdjpy1m usdjpy3m usdjpy6m usdjpy1y usdjpy2y)
refmap=(fx_curve=“JPY:USD”);
   The component rates can be calculated by multiplying the rates at the respective maturities as follows:
usdjpy1m=usdeur1m*eurjpy1m;
usdjpy3m=usdeur3m*eurjpy3m;
usdjpy6m=usdeur6m*eurjpy6m;
usdjpy1y=usdeur1y*eurjpy1y;
usdjpy2y=usdeur2y*eurjpy2y.
   These calculations can define the future conversion curve from JPY to USD. This future conversion curve can be outputted (e.g., for use by a user of the system). Additionally, the curve or the sequence and direction of the path components can be saved as a known conversion curve (e.g., for use in future calculations).

FIG. 11 is a directed graph depicting example known conversion curves. In this example, the known conversion curves can be stored in the following data structures:

array usdeurc fx tocur=USD fromcur=EUR
elements=(usdeur1m usdeur3m usdeur6m usdeur1y usdeur2y)
refmap=(fx_curve=“EUR:USD”);

array jpyeurc fx tocur=JPY fromcur=EUR
elements=(jpyeur1m jpyeur3m jpyeur9m jpyeur1y jpyeur2y)
refmap=(fx_curve=“EUR:JPY”);

In this example, when a future conversion curve from JPY to USD is requested, a shortest path algorithm returns JPY->EUR->USD. Translating this short path to the known conversion curves identifies {jpyeurc(R), usdeurc(F)}, where a reverse link from JPY to EUR is included and denoted by an (R) identifier. The use of the reverse link indicates multiplication by inverse rates during the numerical calculation.

The known conversion curves of the shortest path can be tested for consistent maturities. In this case, inconsistent maturities are found, where the EUR->USD curve contains maturities at {1m, 3m, 6m, 1y, 2y} while the EUR->JPY curve contains maturities at {1m, 3m, 9m, 1y, 2y}. To normalize the two curves along the identified shortest path, maturities at the union of these two sets (i.e., {1m, 3m, 6m, 9m, 1y, 2y}) can be determined, with missing values in the known conversion curves being estimated using linear interpolation. To accomplish this normalization, new variables are declared representing the EUR->JPY curve at 6 months and the EUR->USD curve at 9 months, as follows:
jpyeur6m num fx tocur=JPY fromcur=EUR maturity=6 month;
usdeur9m num fx tocur=USD fromcur=EUR maturity=9 month.
   Values for the newly declared variables can be estimated using linear interpolation or another estimation process. The new future conversion curve from JPY to USD can then be declared as follows:

usdjpy1m num fx tocur=USD fromcur=JPY maturity=1 month,

usdjpy3m num fx tocur=USD fromcur=JPY maturity=3 month,

usdjpy6m num fx tocur=USD fromcur=JPY maturity=6 month,

usdjpy9m num fx tocur=USD fromcur=JPY maturity=9 month,

usdjpy1y num fx tocur=USD fromcur=JPY maturity=1 year,

usdjpy2y num fx tocur=USD fromcur=JPY maturity=2 year.

and

array usdjpyc fx tocur=USD fromcur=JPY
elements=(usdjpy1m usdjpy3m usdjpy6m usdjpy9m usdjpy1y usdjpy2y)
refmap=(fx_curve=“JPY:USD”);
   The conversion rates for the newly declared variables can be calculated utilizing the inverse of the conversion rates from the known EUR->JPY curve, and based upon the reverse traversal of that conversion in the shortest path, as follows:
usdjpy1m=usdeur1m*(1/jpyeur1m);
usdjpy3m=usdeur3m*(1/jpyeur3m);
usdjpy6m=usdeur6m*(1/jpyeur6m);
usdjpy9m=usdeur9m*(1/jpyeur9m);
usdjpy1y=usdeur1y*(1/jpyeur1y);
usdjpy2y=usdeur2y*(1/jpyeur2y).

In the previous two examples, only one possible path was present in the directed graph of known conversion curves. A graph constructed from a larger database of forward conversion curves can provide multiple paths between desired nodes. The following arrays describe five known curves and weights associated with those types of forward conversion curves:

array usdgbpc fx tocur=GBP fromcur=USD
elements=(usdgbp1m usdgbp3m usdgbp6m usdgbp1y usdgbp2y)
refmap=(fx_curve=“USD:GBP”) weight=1;

array gbpjpyc fx tocur=JPY fromcur=GBP
elements=(gbpjpy1m gbpjpy3m gbpjpy6m gbpjpy1y gbpjpy2y)
refmap=(fx_curve=“GBP:JPY”) weight=2;

array usdeurc fx tocur=EUR fromcur=USD
elements=(usdeur1m usdeur3m usdeur6m usdeur1y usdeur2y)
refmap=(fx_curve=“USD:EUR”) weight=1;

array gbpjpyc fx tocur=JPY fromcur=GBP
elements=(gbpjpy1m gbpjpy3m gbpjpy6m gbpjpy1y gbpjpy2y)
refmap=(fx_curve=“GBP:JPY”) weight=1;

array eurjpyc fx tocur=JPY fromcur=EUR
elements=(eurjpy1m eurjpy3m eurjpy6m eurjpy1y eurjpy2y)
refmap=(fx_curve=“EUR:JPY”) weight=1;
   As an example, a directed graph depicting the relationship among five defined conversion curve arrays is depicted in FIG. 7.

Referring again to FIG. 7, upon receiving a request for a future conversion curve from USD to JPY, a future conversion curve calculator can identify the following three paths from USD to JPY using the known conversion curves:
USD->GBP->JPY; USD->GBP->EUR->JPY; and USD->EUR->JPY.
   A shortest path algorithm can find the lowest cost path out of these identified paths (e.g., based upon the weights associated with each path. This calculation can be represented as:

Costⱼ=Σwᵢ,

for each of the j identified paths, where wᵢ is a weight for an i-th conversion on the j-th path. As noted in the above defined arrays, the GBP->JPY curve has a weight of 2. The identified paths are calculated to have the following costs/weights:

USD->GBP->JPY=3;

USD->GBP->EUR->JPY=3;

USD->EUR->JPY=2.

Thus, the USD->EUR->JPY path is selected as the least cost path, and it is used to generate the future conversion curve from USD->JPY. Additionally, the USD->EUR and EUR->JPY curves can be collapsed to form the USD->JPY conversion curve.

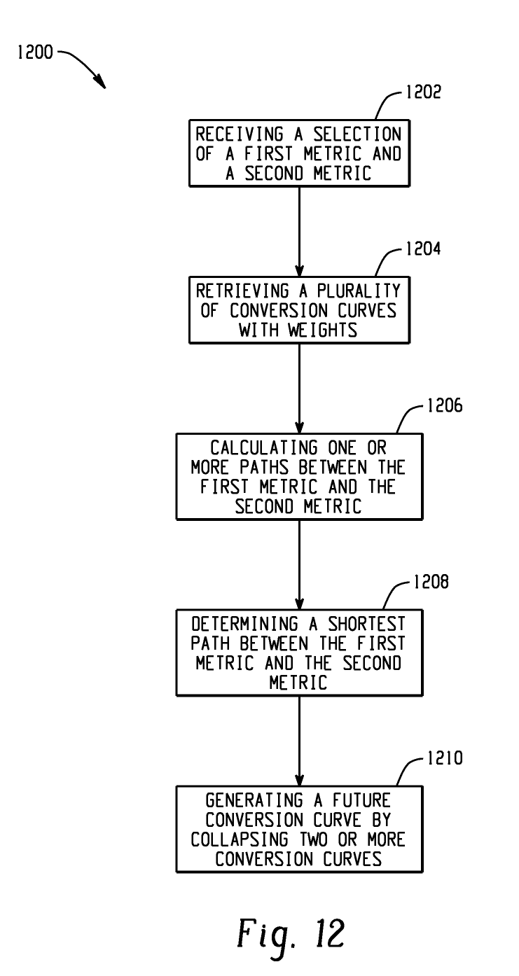

FIG. 12 is a flow diagram depicting an example computer-implemented method for determining a future conversion curve between a first metric and a second metric. A selection of a first metric and a second metric is received at 1202 using one or more processors. At 1204, a plurality of conversion curves are retrieved, where each conversion curve has a corresponding weight, and where each conversion curve identifies a plurality of future conversions between a source metric and a target metric. One or more paths between the first metric and the second metric are calculated at 1206 using two or more conversion curves, where each path begins with the first metric and ends with the second metric, and where each path is associated with a path weight based upon the sum of the weights used to calculate that path. A shortest path between the first metric and the second metric is determined at 1208, where the shortest path is the path having the least weight. At 1210, a future conversion curve is generated by collapsing the two or more conversion curves of the shortest path.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus.

The computer-readable medium can be a machine-readable storage device, a machine-readable storage substrate, a memory device, a composition of matter generating a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them, A propagated signal is an artificially generated signal, e.g., a machine-generated electrical, optical, or electromagnetic signal, that is generated to encode information for transmission to suitable receiver apparatus.

A computer program (also known as a program, software, software application, script, or code), can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., on or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of nonvolatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) to LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any from, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed o a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer-implemented method for determining a future conversion curve between a first metric and a second metric, the method comprising:
receiving a first metric and a second metric;
retrieving a plurality of conversion curves, the conversion curves having a corresponding weight, and each conversion curve identifying a plurality of future conversions between a source metric and a target metric;
calculating, using one or more processors, one or more paths between the first metric and the second metric using two or more conversion curves, wherein each path begins with the first metric and ends with the second metric, and wherein each path is associated with a path weight based upon the sum of the weights used to calculate that path;
determining a shortest path between the first metric and the second metric, wherein the shortest path is the path having the least weight; and
generating a future conversion curve by collapsing the two or more conversion curves of the shortest path.

2. The method of claim 1, wherein each conversion curve in the plurality of conversion curves is associated with a plurality of future times, and wherein the two or more conversion curves of the shortest path are normalized with respect to one another.

3. The method of claim 2, wherein normalizing includes linear interpolation or spline interpolation.

4. The method of claim 1, wherein one of the one or more paths between the first metric and the second metric includes a backward link from a target metric to a source metric.

5. The method of claim 4, wherein the backward link has the same weight as a corresponding forward link.

6. The method of claim 1, wherein each conversion curve in the plurality of conversion curves is associated with a plurality of future times, and wherein collapsing two or more conversion curves further comprises:
calculating a product for each conversion curve at a predetermined future time, and
generating a future conversion curve based upon the calculated product.

7. The method of claim 1, wherein each conversion curve in the plurality of conversion curves is associated with a plurality of future times, wherein an inverse future conversion is used when a backward link is present in the shortest path, and wherein collapsing two or more conversion curves further comprises:
calculating a product for each inverse future conversion curve at a predetermined future time, and
generating an inverse future conversion curve based upon the calculated product.

8. The method of claim 1, wherein each weight is equal, and wherein the shortest path between the first metric and the second metric includes the fewest number of conversion curves.

9. The method of claim 1, wherein the one or more paths between the first metric and the second metric is calculated using a Dijkstra's algorithm or a Bellman-Ford algorithm.

10. The method of claim 1, wherein the path having the least weight is chosen from a path having the highest sum of weights or a path having the lowest sum of weights.

11. The method of claim 1, wherein calculating one or more paths does not include calculating all possible paths between the first metric and the second metric.

12. A computer-implemented system for determining a future conversion curve between a first metric and a second metric, comprising:
one or more processors;
one or more computer-readable storage mediums containing software instructions executable on the one or more processors to cause the one or more processors to perform operations including:
receiving, using one or more processors, a first metric and a second metric;
retrieving a plurality of conversion curves, the conversion curves having a corresponding weight, and each conversion curve identifying a plurality of future conversions between a source metric and a target metric;
calculating one or more paths between the first metric and the second metric using two or more conversion curves, wherein each path begins with the first metric and ends with the second metric, and wherein each path is associated with a path weight based upon the sum of the weights used to calculate that path;
determining a shortest path between the first metric and the second metric, wherein the shortest path is the path having the least weight; and
generating a future conversion curve by collapsing the two or more conversion curves of the shortest path.

13. The system of claim 12, wherein each conversion curve in the plurality of conversion curves is associated with a plurality of future times, and wherein the two or more conversion curves of the shortest path are normalized with respect to one another.

14. The system of claim 13, wherein normalizing includes linear interpolation or spline interpolation.

15. The system of claim 12, wherein one of the one or more paths between the first metric and the second metric includes a backward link from a target metric to a source metric.

16. The system of claim 12, wherein each conversion curve in the plurality of conversion curves is associated with a plurality of future times, and wherein collapsing two or more conversion curves further comprises:
calculating a product for each conversion curve at a predetermined future time, and
generating a future conversion curve based upon the calculated product.

17. The system of claim 12, wherein each conversion curve in the plurality of conversion curves is associated with a plurality of future times, wherein an inverse future conversion is used when a backward link is present in the shortest path, and wherein collapsing two or more conversion curves further comprises:
calculating a product for each inverse future conversion curve at a predetermined future time, and
generating an inverse future conversion curve based upon the calculated product.

18. The system of claim 12, wherein calculating one or more paths does not include calculating all possible paths between the first metric and the second metric.

19. A computer-readable storage medium encoded with instructions that when executed on one or more processors within a computer system command the one or more processors to perform a method of determining a future conversion curve between a first metric and a second metric, the method comprising:
receiving, using one or more processors, a first metric and a second metric;
receiving a plurality of conversion curves, the conversion curves having a corresponding weight, and each conversion curve identifying a plurality of future conversions between a source metric and a target metric;
calculating one or more paths between the first metric and the second metric using two or more conversion curves, wherein each path begins with the first metric and ends with the second metric, and wherein each path is associated with a path weight based upon the sum of the weights used to calculate that path;
determining a shortest path between the first metric and the second metric, wherein the shortest path is the path having the least weight; and
generating a future conversion curve by collapsing the two or more conversion curves of the shortest path.
